(19) United States
(12) Patent Application Publication
(10) Pub. No.: US 2018/0205612 A1
(43) Pub. Date: Jul. 19, 2018

(54) CLUSTERED CONTAINERIZED APPLICATIONS

(71) Applicant: Portworx, Inc., Los Altos, CA (US)

(72) Inventors: Goutham Rao, Los Altos, CA (US); Vinod Jayaraman, San Francisco, CA (US)

(73) Assignee: Portworx, Inc., Los Altos, CA (US)

(21) Appl. No.: 15/597,032

(22) Filed: May 16, 2017

Related U.S. Application Data
(60) Provisional application No. 62/446,208, filed on Jan. 13, 2017.

(51) Int. Cl. H04L 12/24; H04L 29/08; H04L 12/26; G06F 9/445

(52) U.S. Cl. CPC H04L 41/12; G06F 8/61; H04L 43/10; H04L 67/1097

(57) ABSTRACT

Disclosed herein are systems, methods, and devices for the implementation of clustered containerized software applications. Methods may include identifying, using a processor of a first storage container node, a storage container node cluster including a plurality of storage container nodes, and sending a packet to at least a second storage container node of the plurality of storage container nodes. The methods may also include receiving a response from the second storage container node, the response including a reply to the packet, and generating a distance map based, at least in part, on the received response, the distance map characterizing a plurality of distances between the plurality of storage container nodes and the first storage container node. The methods may further include identifying at least one additional storage container node based, at least in part, on the generated distance map.

### CROSS-REFERENCE TO RELATED APPLICATIONS

This application claims the benefit under 35 U.S.C. § 119(e) of U.S. Provisional Patent Application No. 62/446,208, filed on Jan. 13, 2017, which is incorporated herein by reference in its entirety for all purposes.

### TECHNICAL FIELD

The present disclosure relates generally to containerized applications and more specifically to containerized scalable storage applications.

### DESCRIPTION OF RELATED ART

One of the most difficult challenges facing software developers is interoperability of software between different computing environments. Software written to run in one operating system typically will not run without modification in a different operating system. Even within the same operating system, a program may rely on other programs in order to function. Each of these dependencies may or may not be available on any given system, or may be available but in a version different from the version originally relied upon. Thus, dependency relationships further complicate efforts to create software capable of running in different environments.

In recent years, the introduction of operating-system-level virtualization has facilitated the development of containerized software applications. A system configured with operating-system-level virtualization includes a container engine that operates on top of the operating system. Importantly, the container engine is configured to operate interchangeably in different environments (e.g., with different operating systems). At the same time, the container engine is configured to present a standardized interface to one or more software containers.

Each software container may include computer programming code for performing one or more tasks. Examples of software containers include web servers, email servers, web applications, and other such programs. Each software container may include some or all of the software resources that the software in the container needs in order to function. For example, if a software container includes a web application written in the Python programming language, the software container may also include the Python programming language modules that the web application relies upon. In this way, the software container may be installed and may execute successfully in different computing environments as long as the environment includes a container engine.

### SUMMARY

Disclosed herein are systems, methods, and devices for the implementation of clustered containerized software applications. Methods may include identifying, using a processor of a first storage container node, a storage container node cluster including a plurality of storage container nodes, and sending a packet to at least a second storage container node of the plurality of storage container nodes. The methods may also include receiving a response from the second storage container node, the response including a reply to the packet, and generating a distance map based, at least in part, on the received response, the distance map characterizing a plurality of distances between the plurality of storage container nodes and the first storage container node. The methods may further include identifying at least one additional storage container node based, at least in part, on the generated distance map.

In some embodiments, the packet is an internet control message protocol (ICMP). In various embodiments, the generating of the distance map further includes generating at least one distance metric based on the sending of the ICMP packet and the receiving of the response, the distance metric characterizing a number of intermediary network components that exist between the first and second storage container nodes. In some embodiments, the identifying of the at least one additional storage container node is further based on at least one distance parameter characterizing a physical distance constraint applied to data storage in the storage container node cluster. In various embodiments, the identifying of the at least one additional storage container node is further based on a replication factor characterizing a number of additional storage container nodes data is to be replicated to.

According to various embodiments, the methods may also include sending a packet to each of the plurality of storage container nodes, and receiving a response from each of the plurality of storage container nodes. In some embodiments, the plurality of distances characterized by the distance map identifies a distance metric associated with each of the plurality of storage container nodes. In various embodiments the identifying of the at least one additional storage container node further includes identifying a plurality of additional storage container nodes for implementation of data replication and propagation services associated with the first storage container node.

Also disclosed herein are systems that may include a storage device configured to implement a first storage container node that is configured to store data for providing a containerized application system configured to run a plurality of application instances. The systems may further include a processor configured to identify a storage container node cluster including a plurality of storage container nodes, send a packet to at least a second storage container node of the plurality of storage container nodes, and receive a response from the second storage container node, the response including a reply to the packet. The processor may also be configured to generate a distance map based, at least in part, on the received response, the distance map characterizing a plurality of distances between the plurality of storage container nodes and the first storage container node, and identify at least one additional storage container node based, at least in part, on the generated distance map.

In some embodiments, the packet is an internet control message protocol (ICMP). In various embodiments, the processor is further configured to generate at least one distance metric based on the sending of the ICMP packet and the receiving of the response, the distance metric characterizing a number of intermediary network components that exist between the first and second storage container nodes. According to various embodiments, the identifying of the at least one additional storage container node is further based on at least one distance parameter characterizing a physical distance constraint applied to data storage in the storage container node cluster. In various embodiments, the identifying of the at least one additional storage container node is further based on a replication factor characterizing a number of additional storage container nodes data is to be replicated to. According to various embodiments, the processor is further configured to send a packet to each of the plurality of storage container nodes, and receive a response from each of the plurality of storage container nodes. In some embodiments, the plurality of distances characterized by the distance map identifies a distance metric associated with each of the plurality of storage container nodes. In various embodiments, the processor is further configured to identify a plurality of additional storage container nodes for implementation of data replication and propagation services associated with the first storage container node.

Further disclosed herein are one or more non-transitory computer readable media having instructions stored thereon for performing a method, the method comprising identifying, at a first storage container node, a storage container node cluster including a plurality of storage container nodes, sending a packet to at least a second storage container node of the plurality of storage container nodes, and receiving a response from the second storage container node, the response including a reply to the packet. The method may further include generating a distance map based, at least in part, on the received response, the distance map characterizing a plurality of distances between the plurality of storage container nodes and the first storage container node, and identifying at least one additional storage container node based, at least in part, on the generated distance map.

According to various embodiments, the packet is an internet control message protocol (ICMP), and the generating of the distance map further includes generating at least one distance metric based on the sending of the ICMP packet and the receiving of the response, the distance metric characterizing a number of intermediary network components that exist between the first and second storage container nodes. In some embodiments, the identifying of the at least one additional storage container node is further based on at least one distance parameter characterizing a physical distance constraint applied to data storage in the storage container node cluster, and the identifying of the at least one additional storage container node is further based on a replication factor characterizing a number of additional storage container nodes data is to be replicated to. In various embodiments, the method further includes sending a packet to each of the plurality of storage container nodes, and receiving a response from each of the plurality of storage container nodes, where the plurality of distances characterized by the distance map identifies a distance metric associated with each of the plurality of storage container nodes.

### BRIEF DESCRIPTION OF THE DRAWINGS

The disclosure may best be understood by reference to the following description taken in conjunction with the accompanying drawings, which illustrate particular embodiments.

FIG. 1 illustrates an example of an arrangement of components in a containerized storage system.

FIG. 2 illustrates an example of a scalable storage container node system, configured in accordance with one or more embodiments.

FIG. 3 illustrates an example of a storage container node, configured in accordance with one or more embodiments.

FIG. 4 illustrates an example of a method for executing a storage request.

FIG. 5 illustrates an example of a method for initializing a new storage container node within a storage container node cluster.

FIG. 6 illustrates an example of a method for node map generation, implemented in accordance with some embodiments.

FIG. 7 illustrates an example of a data placement method, implemented in accordance with some embodiments.

FIG. 8 illustrates an example of a server.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Techniques and mechanisms described herein provide for the implementation of clustered containerized software applications. A containerized application system is one in which an application instance may be created as a container based on an application image, which itself may be composed of some number of application image layers. As will be discussed in greater detail below, such applications may be implemented in clusters. Accordingly, data may be stored in clusters of storage container nodes. Distance metrics may be determined for different storage container nodes within clusters to generate storage container node maps for such clusters. The storage container node maps may be used to implement distance parameters or constraints on data replication and propagation to improve failover protection within the cluster.

As will be discussed in greater detail below, the implementation of such clustered containerized applications in this manner improves the ability of storage systems to provide fault tolerance for stored data. Accordingly, storage systems disclosed herein provide increases in failover tolerance and protection against catastrophic events which may happen at a particular data center, such as a fire or other disaster. It will be appreciated that storage systems described herein improve fault tolerance against any such event that may result in data loss or corruption. Moreover, storage systems disclosed herein provide additional improvements by reducing the number of nodes used for failover protection by more intelligently selecting nodes in particular regions.

### Example Embodiments

Techniques and mechanisms described herein may facilitate the configuration of a scalable storage container node system. In some embodiments, a scalable storage container node system may allow application containers in a virtualized application system to quickly and directly provision and scale storage. Further, the system may be configured to provide one or more user experience guarantees across classes of applications.

According to various embodiments, the system may pool the capacity of different services into virtual storage volumes and auto-allocate storage as application storage traffic scales or bursts. For instance, a single virtual storage volume may include hundreds or thousands of terabytes of storage space aggregated across many different storage devices located on many different physical machines.

In some embodiments, storage containers may communicate directly with server resources such as hardware storage devices, thus reducing or eliminating unnecessary virtualization overhead. Storage containers may be configured for implementation in a variety of environments, including both local computing environments and cloud computing environments.

In some implementations, storage volumes created according to the techniques and mechanisms described herein may be highly failure-tolerant. For example, a virtual storage volume may include data stored on potentially many different storage nodes. A storage node may fail for any of various reasons, such as hardware failure, network failure, software failure, or server maintenance. Data integrity may be maintained even if one or more nodes that make up a storage volume fail during data storage operations.

An application container is frequently constructed as a series of two or more layers. Each layer may include some number of files. For instance, an application container may include an operating system such as a Linux distribution as a base layer. Then, the application container may include additional layers, such as a MySQL layer and an Nginx layer, that each rely on the files included in the base layer.

Organizing files into layers may facilitate the separation of an application container into more granular components. In some embodiments, a layer may take the form of a tar archive, also known as a tarball. Alternately, a layer may take the form of any other file aggregation mechanism, such as a zip file or a folder of files. Thus, a container may be modified by replacing a single layer with a new version, without having to distribute a new copy of the entire container.

When an application container is loaded into memory for execution, the layers may need to be combined in some way in order to function together. For example, files from a MySQL layer may be combined in memory with files from a base operating system layer to create a functioning whole. The software that unifies layers into a functioning whole may be referred to as an image layer storage driver.

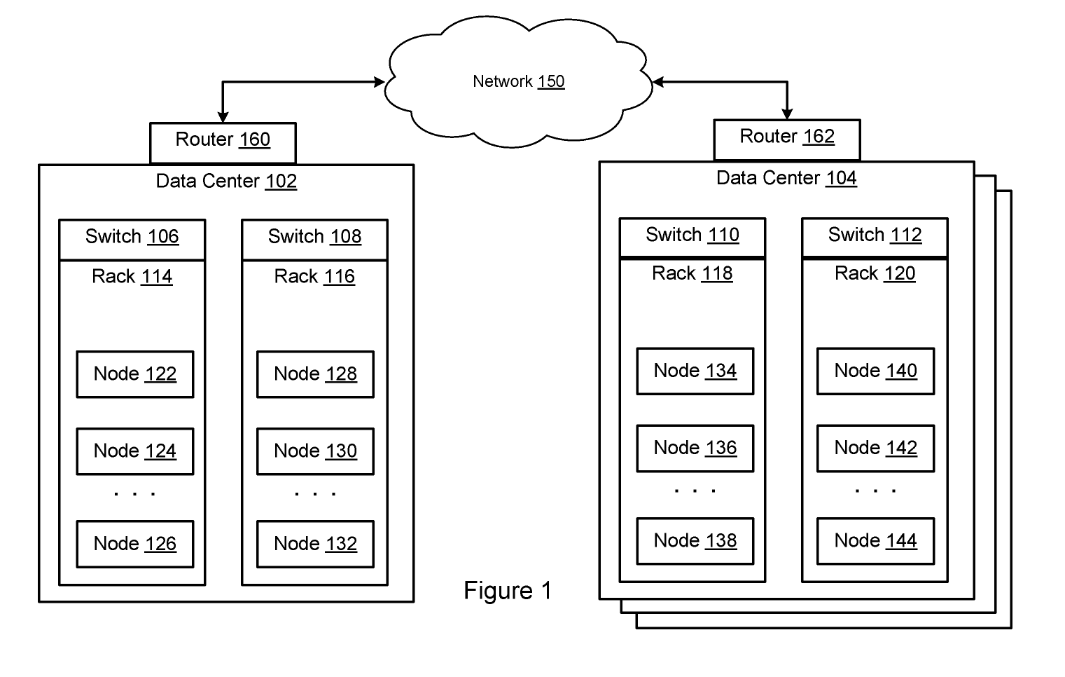

FIG. 1 illustrates an arrangement of components in a containerized storage system. As will be discussed in greater detail below, such an arrangement of components may be configured such that clustered data storage is implemented, and copies of data stored at a particular storage container node within the cluster may be propagated amongst various other storage container nodes such that multiple copies of the data are available in case one of the storage container nodes fails. In various embodiments, and as will be discussed in greater detail below, one or more constraints may be implemented when determining which nodes to use during clustered data storage. For example, one or more distance or geographical constraints may be implemented such that data is propagated amongst nodes that are at least a designated distance from each other. In various embodiments, the implementation of such constraints may increase the effectiveness of failover tolerance as events that may affect one node, such as a power outage or other event, are less likely to affect other nodes to which data has been propagated.

Accordingly, in various embodiments, nodes may be implemented in various data centers, such as data center 102 and data center 104. As similarly discussed above, a data center may include networked computing devices that may be configured to implement various containerized applications, such as storage nodes discussed in greater detail below. In various embodiments, such data centers and storage nodes may be configured to implement clustered storage of data. As discussed in greater detail below, the clustered storage of data may utilize one or more storage container nodes that are collectively configured to aggregate and abstract storage resources for the purpose of performing storage-related operations. Accordingly, data centers, such as data center 102 and data center 104 may each include various nodes underlying data clusters which may be implemented within a data center or across multiple data centers. As will be discussed in greater detail below, distance metrics may be determined to identify distances between such nodes and to implement distance parameters for a particular cluster. While FIG. 1 illustrates data center 102 and data center 104, any number of data centers may be implemented.

As discussed above, the data centers may include various nodes. For example, data center 102 may include node 122, node 124, node 126, node 128, node 130, and node 132. Moreover, data center may include additional nodes, such as node 134, node 136, node 138, node 140, node 142, and node 144. Such nodes may be physical nodes underlying storage nodes discussed in greater detail below. As shown in FIG. 1, nodes may be included in racks, such as rack 114, rack 116, rack 118, and rack 120. In various embodiments, each rack may be coupled with a switch, such as switch 106, switch 108, switch 110, and switch 112. Such switches may manage the flow of data amongst nodes within a particular rack.

Data centers and components within data centers, such as racks including nodes and their associated switches, may be coupled with routers, such as router 160 and router 162. In various embodiments, such routers may manage the flow of data between data centers and other components that may be coupled with a network, such as network 150. In some embodiments, network 150 may be, at least in part, a local network, or may be a global network such as the internet. Accordingly, network 150 may include numerous components and communications pathways that couple data centers with each other. Such components and communications pathways may also be used to generate the distance metrics, as will be discussed in greater detail below.

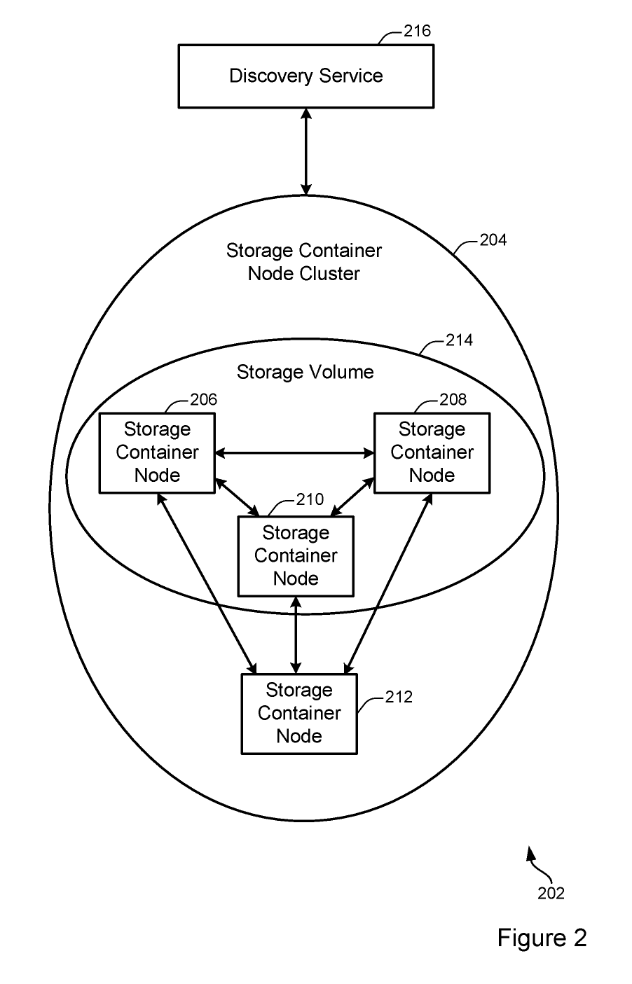

FIG. 2 illustrates an example of a scalable storage container node system 202. In some embodiments, the scalable storage container node system 202 may be capable of providing storage operations within the context of one or more servers configured to implement a container system. The scalable storage container node system 202 includes a storage container node cluster 204, which includes storage container nodes 206, 208, 210, and 212. The storage container nodes 206, 208, and 210 are combined to form a storage volume 214. The scalable storage container node system 202 also includes a discovery service 216 and an application image layer registry 218.

At 204, the storage container node cluster 204 is shown. According to various embodiments, a storage container node cluster may include one or more storage container nodes collectively configured to aggregate and abstract storage resources for the purpose of performing storage-related operations. Although the scalable storage container node system 202 shows only a single storage container node cluster, implementations of the techniques discussed herein may frequently include thousands or millions of storage container node clusters in a scalable storage container node system.

At 206, 208, 210, and 212, storage container nodes are shown. A storage container node may be configured as discussed with respect to the storage container node 202 shown in FIG. 202 or may be arranged in a different configuration. Each storage container node may include one or more privileged storage container such as the privileged storage container 216 shown in FIG. 2.

According to various embodiments, storage container nodes may be configured to aggregate storage resources to create a storage volume that spans more than one storage container node. By creating such a storage volume, storage resources such as physical disk drives that are located at different physical servers may be combined to create a virtual volume that spans more than one physical server.

The storage volume may be used for any suitable storage operations by other applications. For example, the containers 210, 212, and/or 214 shown in FIG. 2 may use the storage volume for storing or retrieving data. As another example, other applications that do not exist as containers may use the storage volume for storage operations.

In some implementations, the storage volume may be accessible to an application through a container engine, as discussed with respect to FIG. 2. For instance, a privileged storage container located at the storage container node 206 may receive a request to perform a storage operation on a storage volume that spans multiple storage nodes, such as the nodes 206, 208, 210, and 212 shown in FIG. 2. The privileged storage container may then coordinate communication as necessary among the other storage container nodes in the cluster and/or the discovery service 216 to execute the storage request.

At 214, a storage volume is shown. According to various embodiments, a storage volume may act as a logical storage device for storing and retrieving data. The storage volume 214 includes the storage container nodes 206, 208, and 210. However, storage volumes may be configured to include various numbers of storage container nodes. A storage volume may aggregate storage resources available on its constituent nodes. For example, if each of the storage container nodes 206, 208, and 210 include 2 terabytes of physical data storage, then the storage volume 214 may be configured to include 6 terabytes of physical data storage.

In some implementations, a storage volume may provide access to data storage for one or more applications. For example, a software application running on any of storage container nodes 206-212 may store data to and/or retrieve data from the storage volume 214. As another example, the storage volume 214 may be used to store data for an application running on a server not shown in FIG. 2.

At 216, a discovery service is shown. According to various embodiments, the discovery service may be configured to coordinate one or more activities involving storage container node clusters and/or storage container nodes. For example, the discovery service may be configured to initialize a new storage container node cluster, destroy an existing storage container node cluster, add or remove a storage container node from a storage container node cluster, identify which node or nodes in a storage container node cluster are associated with a designated storage volume, and/or identify the capacity of a designated storage volume.

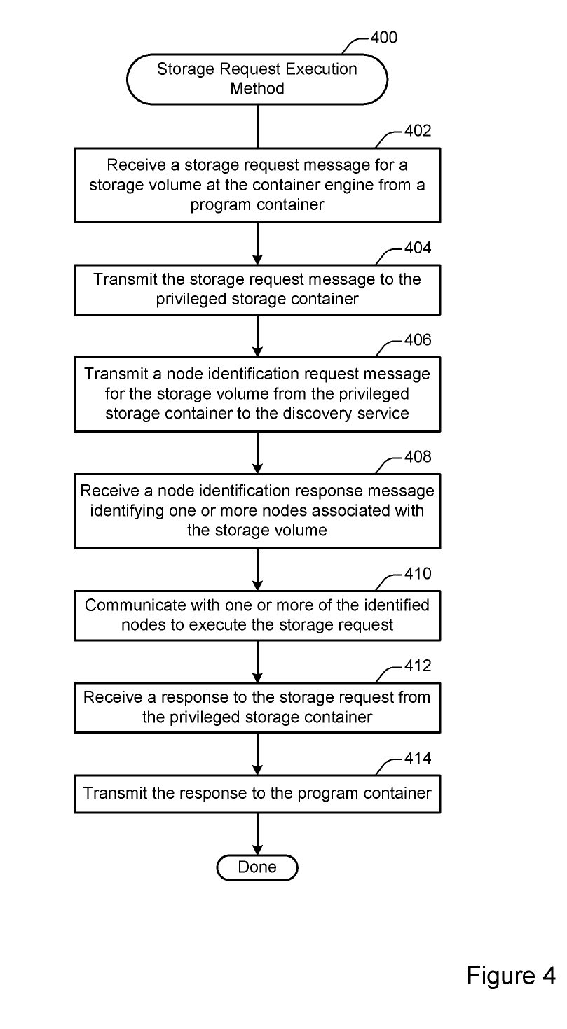

In some implementations, a discovery service may be configured to add a storage container node to a storage container node cluster. An example of such a method is described in additional detail with respect to FIG. 4. In some implementations, a discovery service may be configured to facilitate the execution of a storage request.

According to various embodiments, the discovery service may be configured in any way suitable for performing coordination activities. For instance, the discovery service may be implemented as a distributed database divided among a number of different discovery service node. The discovery service may include a metadata server that store information such as which storage container nodes correspond to which storage container node clusters and/or which data is stored on which storage container node. Alternately, or additionally, the metadata server may store information such as which storage container nodes are included in a storage volume.

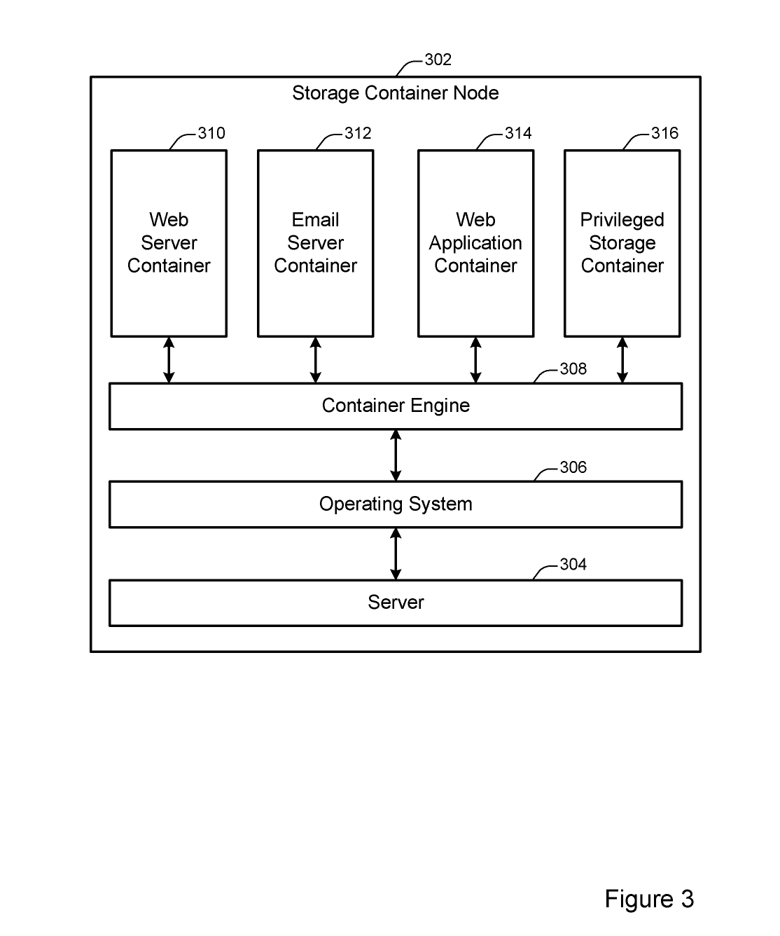

FIG. 3 illustrates an example of a storage container node 302. According to various embodiments, a storage container node may be a server configured to include a container engine and a privileged storage container. The storage container node 302 shown in FIG. 3 includes a server layer 304, an operating system layer 306, a container engine 308, a web server container 310, an email server container 312, a web application container 314, and a privileged storage container 316.

In some embodiments, the storage container node 302 may serve as an interface between storage resources available at a server instance and one or more virtual storage volumes that span more than one physical and/or virtual server. For example, the storage container node 302 may be implemented on a server that has access to a storage device. At the same time, a different storage container node may be implemented on a different server that has access to a different storage device. The two storage nodes may communicate to aggregate the physical capacity of the different storage devices into a single virtual storage volume. The single virtual storage volume may then be accessed and addressed as a unit by applications running on the two storage nodes or at on another system.

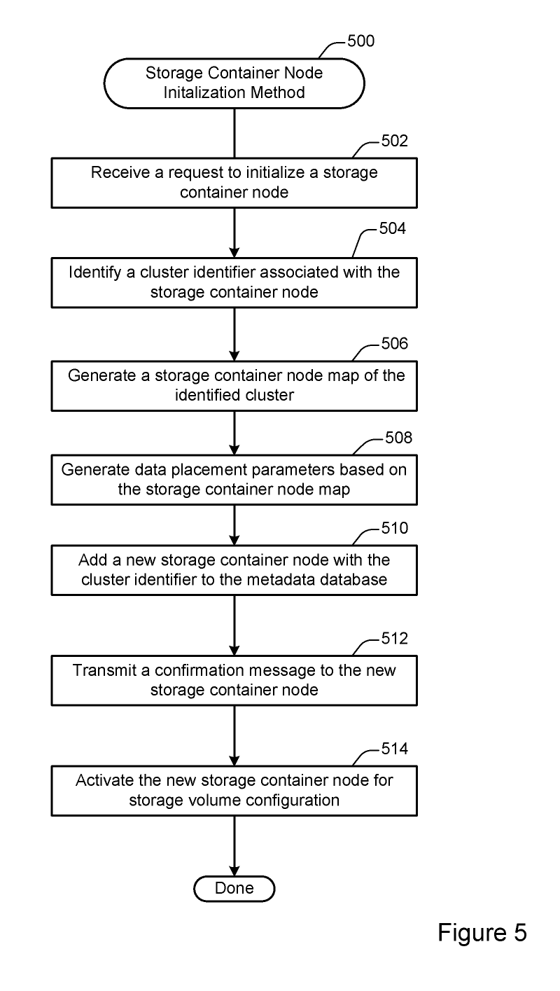

At 304, the server layer is shown. According to various embodiments, the server layer may function as an interface by which the operating system 306 interacts with the server on which the storage container node 302 is implemented. A storage container node may be implemented on a virtual or physical server. For example, the storage container node 302 may be implemented at least in part on the server shown in FIG. 5. The server may include hardware such as networking components, memory, physical storage devices, and other such infrastructure. The operating system layer 306 may communicate with these devices through a standardized interface provided by the server layer 304.

At 306, the operating system layer is shown. According to various embodiments, different computing environments may employ different operating system layers. For instance, a physical or virtual server environment may include an operating system based on Microsoft Windows, Linux, or Apple's OS X. The operating system layer 306 may provide, among other functionality, a standardized interface for communicating with the server layer 304.

At 308, a container engine layer is shown. According to various embodiments, the container layer may provide a common set of interfaces for implementing container applications. For example, the container layer may provide application programming interfaces (APIs) for tasks related to storage, networking, resource management, or other such computing tasks. The container layer may abstract these computing tasks from the operating system. A container engine may also be referred to as a hypervisor, a virtualization layer, or an operating-system-virtualization layer.

In some implementations, the separation of the computing environment into a server layer 304, an operating system layer 306, and a container engine layer 308 may facilitate greater interoperability between software applications and greater flexibility in configuring computing environments. For example, the same software container may be used in different computing environments, such as computing environments configured with different operating systems on different physical or virtual servers.

At storage container node may include one or more software containers. For example, the storage container node 302 includes the web server container 220, the email server container 312, and the web application container 314. A software container may include customized computer code configured to perform any of various tasks. For instance, the web server container 220 may provide files such as webpages to client machines upon request. The email server 312 may handle the receipt and transmission of emails as well as requests by client devices to access those emails. The web application container 314 may be configured to execute any type of web application, such as an instant messaging service, an online auction, a wiki, or a webmail service. Although that storage container node 302 shown in FIG. 3 includes three software containers, other storage container nodes may include various numbers and types of software containers.

At 316, a privileged storage container is shown. According to various embodiments, the privileged storage container may be configured to facilitate communications with other storage container nodes to provide one or more virtual storage volumes. A virtual storage volume may serve as a resource for storing or retrieving data. The virtual storage volume may be accessed by any of the software containers 220, 312, and 314 or other software containers located in different computing environments. For example, a software container may transmit a storage request to the container engine 308 via a standardized interface. The container engine 308 may transmit the storage request to the privileged storage container 316. The privileged storage container 316 may then communicate with privileged storage containers located on other storage container nodes and/or may communicate with hardware resources located at the storage container node 302 to execute the request.

In some implementations, one or more software containers may be afforded limited permissions in the computing environment in which they are located. For example, in order to facilitate a containerized software environment, the software containers 310, 312, and 314 may be restricted to communicating directly only with the container engine 308 via a standardized interface. The container engine 308 may then be responsible for relaying communications as necessary to other software containers and/or the operating system layer 306.

In some implementations, the privileged storage container 316 may be afforded additional privileges beyond those afforded to ordinary software containers. For example, the privileged storage container 316 may be allowed to communicate directly with the operating system layer 306, the server layer 304, and/or one or more physical hardware components such as physical storage devices. Providing the storage container 316 with expanded privileges may facilitate efficient storage operations such as storing, retrieving, and indexing data.

FIG. 4 illustrates an example of a method 400 for executing a storage request among components of a storage container node, performed in accordance with one or more embodiments. For example, the method 400 may be performed at a storage container node such as the node 302 shown in FIG. 3.

At 402, a storage request message for a data volume is received at the container engine from a program container. In some implementations, the storage request message may be received at the container engine 308 shown in FIG. 2 from any of the containers 210, 212, or 214 or any other program container.

According to various embodiments, the storage request message may include any request related to a data storage operation. For instance, the storage request may include a request to retrieve, store, index, characterize, or otherwise access data on a storage volume. The request may be transmitted from any container program configured to perform storage-related operations. For example, the web server container 210 shown in FIG. 2 may transmit a request to retrieve a file from a storage volume for the purpose of transmitting the file via a network. As another example, the email server container 212 may transmit a request to store a received email to a storage volume. As yet another example, the web application container 214 may transmit a request to identify the number and type of files in a folder on a storage volume.

At 404, the storage request is transmitted to the privileged storage container. For example, the container engine 208 may transmit the storage request to the privileged storage container 216 shown in FIG. 2.

According to various embodiments, the storage request may be received from the program container and/or transmitted to the privileged storage container via a standard API. For instance, the container engine 308 may support a standard storage API through which program containers may send and/or receive storage-related operations. Using a standard storage API may allow a program container to communicate interchangeably with different types of storage containers. Alternately, or additionally, using a standard storage API may allow a storage container to communicate interchangeably with different types of program containers.

At 406, a node identification request message is transmitted from the privileged storage container to the discovery service. In some implementations, the node identification request message may identify the storage volume associated with the storage request message. By communicating with the discovery service, the privileged storage container may identify which nodes in the cluster are associated with the storage volume.

At 408, a node identification response message is received at the privileged storage container from the discovery service. In some implementations, the node identification response message may identify one or more nodes associated with the storage volume. For example, if the privileged storage container located at the storage container node 212 shown in FIG. 2 transmitted a node identification request message to the discovery service identifying the storage volume 214, the node identification response message received from the discovery service may identify the storage container nodes 206, 208, and 210 shown in FIG. 2.

At 410, the privileged storage container may communicate with one or more of the identified nodes to execute the storage request. For example, the privileged storage container located at the storage container node 212 shown in FIG. 2 may access networking resources to communicate with one or more of the storage container nodes 206, 208, and 210. Communication may involve, for example, transmitting a file via the network to one or more of the nodes for storage.

In some instances, the privileged storage container may communicate with a single node. For instance, each node in the storage volume may be associated with a designated byte range or other subset of the data stored on the volume. The privileged storage container may then communicate with a particular storage container node to retrieve or store data that falls within the range of data associated with that node.

In some instances, the privileged storage container may communicate with more than one node. For example, the storage request may involve operations relating to data stored on more than one node. As another example, the storage volume may be configured for redundant data storage. In this case, executing a storage request to store data to the volume may involve transmitting storage messages to more than one volume.

At 412, a response to the storage request is received from the privileged storage container. At 414, the response is transmitted to the program container. According to various embodiments, the response may include any suitable information for responding to the storage request. For instance, the response may include a requested file, a confirmation message that data was stored successfully, or information characterizing data stored in a storage value.

In some implementations, the response may be received and requested in a manner similar to that discussed with respect to the receipt and transmission of the storage request discussed with respect to operations 402 and 404. For instance, the response may be received at the container engine 308 shown in FIG. 3 from the privileged storage container 316 and transmitted to the appropriate program container 210, 212, or 214.

FIG. 5 illustrates an example of a method 500 for initializing a new storage container node within a storage container node cluster, performed in accordance with one or more embodiments. The method 500 may be performed at a discovery service such as the discovery service 216 shown in FIG. 2.

At 502, a request to initialize a new storage container node is received. According to various embodiments, the request to initialize a new storage container node may be generated when a storage container node is activated. For instance, an administrator or configuration program may install a storage container on a server instance that includes a container engine to create a new storage container node. The administrator or configuration program may than provide a cluster identifier indicating a cluster to which the storage container node should be added. The storage container node may then communicate with the discovery service to complete the initialization.

At 504, a cluster identifier is identified from the received request. According to various embodiments, the cluster identifier may be included with the received request. Alternately, or additionally, a cluster identifier may be identified in another way, such as by consulting a configuration file.

At 506, a storage container node map may be generated for the identified cluster. As will be discussed in greater detail below, the storage container node map may be configured to identify several storage container nodes as well as distances between the storage container nodes. In some embodiments, the storage container nodes included in the storage container node map may be included in a cluster, such as the cluster identified during operation 504. Accordingly, during operation 506 a storage container node map may be generated that identifies storage containers included in the cluster identified by the cluster identifier, as well as distances between nodes of the cluster. As will be discussed in greater detail below, such distances may be represented by distance metrics that characterize one or more features of a connection between nodes. For example, the distance metric may identify a number of intermediate components between nodes, and/or latency information associated with such components such as response times, transmission times, and storage times.

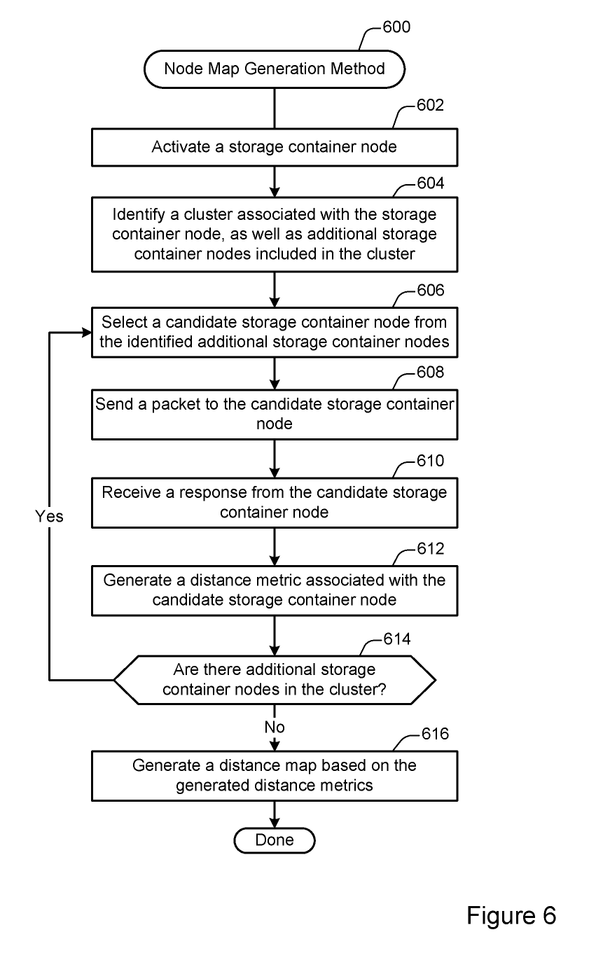

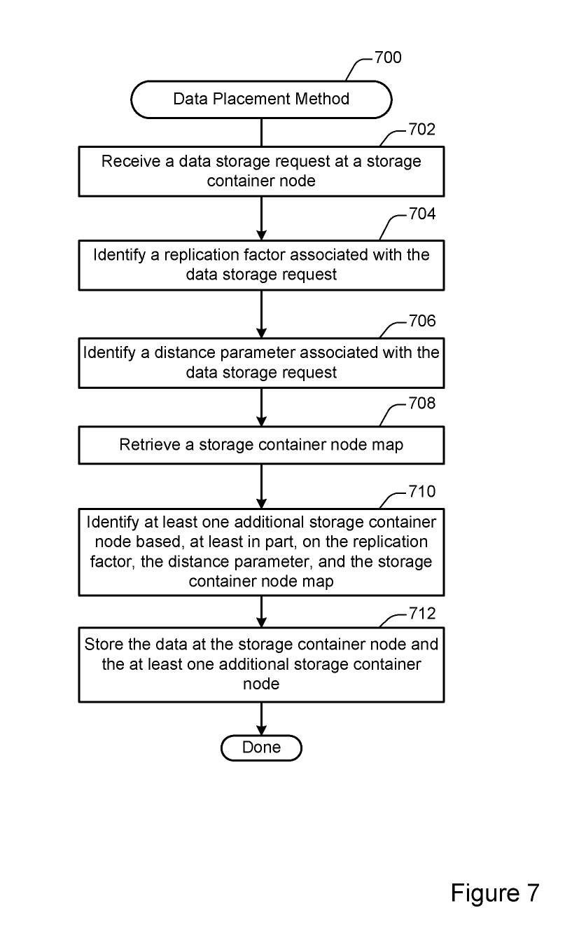

At 508, data placement parameters may be generated based on the storage container node map. In various the data placement parameters may be one or more parameters that configure and identify which storage container nodes a particular storage container node may propagate data to. For example, several storage container nodes may be identified based on their determined distance metrics specified by the storage container node map. In one example, the distances between all nodes and a particular node may be compared with a designated distance value. In various embodiments, the designated distance value may identify a particular distance that should be maintained between one or more nodes in clustered data storage. Accordingly, the distances identified by the storage container node map may be compared with the designated distance value, and storage container nodes having a distance greater than the designated distance value may be determined to be usable for clustered data storage. Additional details of such generation and utilization of storage container node maps and data placement parameters are discussed in greater detail below with reference to FIG. 6 and FIG. 7.

At 510, a new storage container node having the cluster identifier may be added to a metadata database. In some implementations, the metadata database may be implemented at the discovery service and may include various types of information for configuring the storage container node system. The metadata database may identify one or more clusters corresponding to each storage container node. For example, the metadata database may include a row of data that includes both the cluster identifier and an identifier specific to the new storage container node.

At 512, a confirmation message is transmitted to the new storage container node. According to various embodiments, the confirmation message may indicate to the new storage container node that initialization was successful and that the new storage container node is ready to be included in a storage container volume.

At 514, the new storage container node is activated for storage volume configuration. According to various embodiments, activating a storage container node for storage volume configuration may include responding to one or more requests to add the storage container node to a storage volume. For instance, an administrator or configuration program may transmit a request to the discovery service to add the new storage container node to a designated storage volume. The discovery service may then update configuration information in the metadata server to indicate that the designated storage volume includes the new storage container node. Then, the discovery service may direct subsequent requests involving the designated storage volume to the new storage container node or any other storage container node associated with the designated storage volume.

FIG. 6 illustrates an example of a node map generation method, implemented in accordance with some embodiments. Method 600 may commence with operation 602 during which a storage container node may be activated. As similarly discussed above, activating a storage container node for storage volume configuration may include responding to one or more requests to add the storage container node to a storage volume. For instance, an administrator or configuration program may transmit a request to the discovery service to add the new storage container node to a designated storage volume. The discovery service may then update configuration information in the metadata server to indicate that the designated storage volume includes the new storage container node. Then, the discovery service may direct subsequent requests involving the designated storage volume to the new storage container node or any other storage container node associated with the designated storage volume.

Method 600 may proceed to operation 604 during which a cluster associated with the storage container node may be identified. In some embodiments, the storage container node and/or storage volume may be associated with a cluster identifier. For example, the cluster identifier may be included in a received request or may be stored in a configuration file. In some embodiments, the cluster identifier may be generated as part of the activation process during operation 602. In various embodiments, additional storage container nodes may also be identified. The additional storage container nodes may be included in the identified cluster. Accordingly, other storage container nodes included in the identified cluster may be identified based on a configuration file or metadata stored and maintained by the metadata database.

Method 600 may proceed to operation 606 during which a candidate storage container node may be selected from the identified additional storage container nodes. In some embodiments, the additional storage container nodes may be utilized as potential candidate storage container nodes, and a particular storage container node may be selected in any suitable way. For example, the candidate storage container node may be selected randomly from the additional storage container nodes. In another example, the additional storage container nodes may be identified and represented as a list, and the candidate storage container node may be selected from the list in order.

Method 600 may proceed to operation 608 during which a packet may be sent to the candidate storage container node. In various embodiments, the packet may be an internet control message protocol (ICMP) packet, and the ICMP packet may be sent from the storage container node that was activated to the candidate storage container node. As will be discussed in greater detail below, the ICMP packet may be sent from the activated storage container node and may be passed along through any intermediary network components that may be between the activated storage container node and the candidate storage container node. Such intermediary components may be network components such as servers, routers, and other networking devices. While various embodiments disclosed herein describe the use of an ICMP packet, any suitable data packet or message may be used.

Method 600 may proceed to operation 610 during which a response may be received from the candidate storage container node. Accordingly, in response to receiving the ICMP packet, the candidate storage container node may generate a response and send the response back to the activated storage container node. The activated storage container node may receive the response, and may use the response to generate a distance metric, as will be discussed in greater detail below. While the transmission and response of packets has been described between the activated storage container node and the candidate storage container node, in some embodiments, other packet transmissions may be triggered as well. For example, in response to receiving the ICMP packet, the candidate storage container node may also transmit ICMP packets to the additional storage node to generate a node map from the candidate storage container node's perspective. In this way, the generation of several node maps may be triggered, and distance metrics, discussed in greater detail below, may be generated for distances between each of the additional storage container nodes.

Method 600 may proceed to operation 612 during which a distance metric may be generated based on the response. In various embodiments, the distance metric may be a metric that characterizes the distance between storage container nodes. The distance may be a physical or geographical distance. The distance metric may be determined based on the contents of the response to the ICMP packet, which may identify how many intermediary components the response passed through, and thus may identify how many “hops” a data packet has taken. The number of “hops” or intermediary components may be used to infer the distance between storage container nodes. In some embodiments, such a number of “hops” may be combined with latency information to further characterize the distance between storage container nodes. In various embodiments, the distance metric may be a number characterizing the number of intermediary components, may be a normalized number that has been normalized to a particular scale, or may be a composite metric or number generated based on the number of intermediary components and one or more latencies.

Method 600 may proceed to operation 614 during which it may be determined if there are additional storage container nodes included in the cluster. In various embodiments, such a determination may be made based on one or more identifiers associated with the additional storage container nodes identified at operation 604. In some embodiments, such identifiers may be flags or bits used to track which of the additional storage container nodes have been used to generate distance metrics, and which of the additional storage container nodes have not. Accordingly, the flags may be analyzed, and if it is determined that there are additional storage container nodes in the cluster, method 600 may return to operation 606 and another candidate storage container node may be selected. If it is determined that there are no additional storage container nodes, method 600 may proceed to operation 616.

Accordingly, method 600 may proceed to operation 616 during which a distance map or node map may be generated based on the generated distance metrics. In various embodiments, the node map may be a data structure that characterizes distances between the storage container nodes in an identified cluster. More specifically, the node map may characterize distances between the activated storage container node and all of the other storage container nodes included in the cluster associated with the activated storage container node. In various embodiments, such a node map may be generated by combining the previously generated distance metrics into a single data structure characterizing the activated storage container node, the additional storage container nodes, and the distances between the activated storage container node and each of the additional storage container nodes. In some embodiments, the node map may further identify distances between each of the additional storage container nodes.

FIG. 7 illustrates an example of a data placement method, implemented in accordance with some embodiments. Method 700 may commence with operation 702 during which a data storage request may be received at a storage container node. In various embodiments, the data storage request may be received from a client machine or an application executing on such a client machine. As will be discussed in greater detail below, the data storage request may include one or more data values for storage in the storage container node as well as other additional storage container nodes included in a particular cluster.

Method 700 may proceed to operation 704 during which a replication factor may be identified. In various embodiments, the replication factor may characterize a number of additional storage container nodes that the data is replicated to so that clustered storage may be implemented, and failover tolerance may be implemented. In some embodiments, the replication factor may be identified based on one or more cluster parameters that may be included in a configuration file. In various embodiments, the replication factor may be specified as part of the data storage request.

Method 700 may proceed to operation 706 during which a distance parameter may be identified. In various embodiments, the distance parameter may characterize a designated distance that should be maintained between the storage container node at which the data storage request is received, and other additional storage container nodes that the data is replicated to. In various embodiments, the distance parameter may further characterize distances that should be maintained between one or more pairs of the additional storage container nodes. In this way, and as discussed in greater detail below, a distance parameter may be used to configure a replication set to maintain designated physical and geographical distances between storage container nodes, and to increase failover and fault tolerance within a cluster. In various embodiments, such distance parameters may be set to a default value, which may be designated by a system administrator. In various embodiments, such distance parameters may be user specified.

Method 700 may proceed to operation 708 during which a storage container node map may be retrieved. As discussed above with reference to FIG. 6, a node map may be generated. In some embodiments, such a node map may be generated when a storage container node is activated. In various embodiments, such a node map may be generated dynamically and in response to receiving a data storage request. Accordingly, during operation 708, a node map may be retrieved for the storage container node at which the data storage request was received.

Method 700 may proceed to operation 710 during which at least one additional storage container node may be identified based, at least in part, on the replication factor, the distance parameter, and the storage container node map. Accordingly, during operation 710, a replication set may be identified. Such a replication set may identify one or more additional storage container nodes to which data included in the data storage request should be replicated. The additional storage container nodes may be identified based on a comparison of the distance metrics included in the node map with the distance parameters. Accordingly, the distance parameters may be used to identify additional storage container nodes that comply with the constraints set forth by the distance parameters.

Method 700 may proceed to operation 712 during which the data may be stored at the storage container node and the at least one additional storage container node. Accordingly, the data included in the data storage request may be stored in the storage container node, and may be replicated and stored at the additional storage container nodes that were determined to be included in the replication set. One or more other components, such as a metadata database, may be updated responsive to the data storage operation.

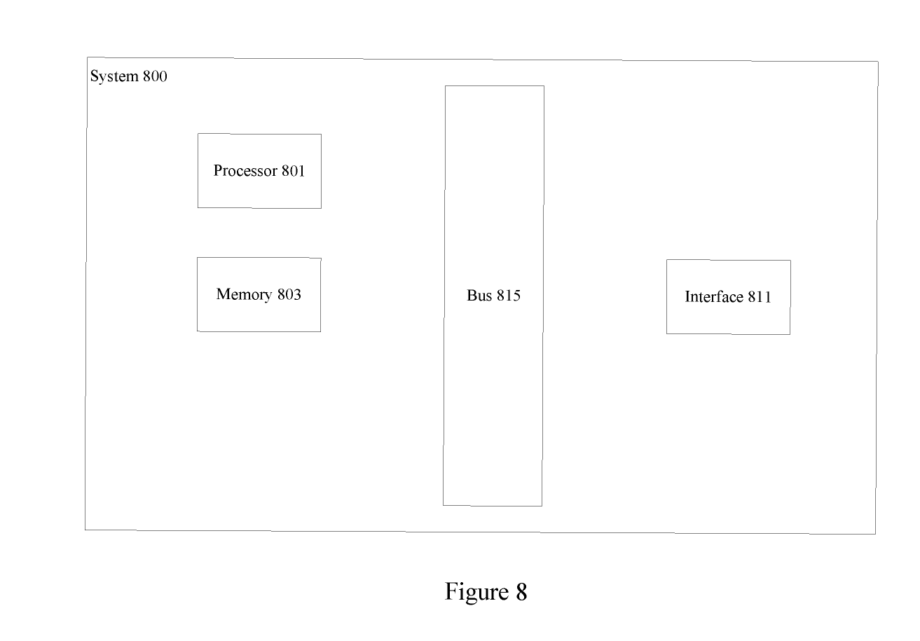

FIG. 8 illustrates one example of a server. According to particular embodiments, a system 800 suitable for implementing particular embodiments of the present invention includes a processor 801, a memory 803, an interface 811, and a bus 815 (e.g., a PCI bus or other interconnection fabric) and operates as a streaming server. When acting under the control of appropriate software or firmware, the processor 801 is responsible for modifying and transmitting live media data to a client. Various specially configured devices can also be used in place of a processor 801 or in addition to processor 801. The interface 811 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 800 is a server configured to run a container engine. For example, the system 800 may be configured as a storage container node as shown in FIG. 1. The server may include one or more hardware elements as shown in FIG. 8. In some implementations, one or more of the server components may be virtualized. For example, a physical server may be configured in a localized or cloud environment. The physical server may implement one or more virtual server environments in which the container engine is executed. Although a particular server is described, it should be recognized that a variety of alternative configurations are possible. For example, the modules may be implemented on another device connected to the server.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
identifying, using a processor of a first storage container node, a storage container node cluster including a plurality of storage container nodes;
sending a packet to at least a second storage container node of the plurality of storage container nodes;
receiving a response from the second storage container node, the response including a reply to the packet;
generating a distance map based, at least in part, on the received response, the distance map characterizing a plurality of distances between the plurality of storage container nodes and the first storage container node; and
identifying at least one additional storage container node based, at least in part, on the generated distance map.

2. The method of claim 1, wherein the packet is an internet control message protocol (ICMP).

3. The method of claim 2, wherein the generating of the distance map further comprises:
generating at least one distance metric based on the sending of the ICMP packet and the receiving of the response, the distance metric characterizing a number of intermediary network components that exist between the first and second storage container nodes.

4. The method of claim 1, wherein the identifying of the at least one additional storage container node is further based on at least one distance parameter characterizing a physical distance constraint applied to data storage in the storage container node cluster.

5. The method of claim 4, wherein the identifying of the at least one additional storage container node is further based on a replication factor characterizing a number of additional storage container nodes data is to be replicated to.

6. The method of claim 1 further comprising:
sending a packet to each of the plurality of storage container nodes; and
receiving a response from each of the plurality of storage container nodes.

7. The method of claim 6, wherein the plurality of distances characterized by the distance map identifies a distance metric associated with each of the plurality of storage container nodes.

8. The method of claim 7, wherein the identifying of the at least one additional storage container node further comprises:
identifying a plurality of additional storage container nodes for implementation of data replication and propagation services associated with the first storage container node.

9. A system comprising:
a storage device configured to implement a first storage container node that is configured to store data for providing a containerized application system configured to run a plurality of application instances; and
a processor configured to:
identify a storage container node cluster including a plurality of storage container nodes;
send a packet to at least a second storage container node of the plurality of storage container nodes;
receive a response from the second storage container node, the response including a reply to the packet;
generate a distance map based, at least in part, on the received response, the distance map characterizing a plurality of distances between the plurality of storage container nodes and the first storage container node; and
identify at least one additional storage container node based, at least in part, on the generated distance map.

10. The system of claim 9, wherein the packet is an internet control message protocol (ICMP).

11. The system of claim 10, wherein the processor is further configured to:
generate at least one distance metric based on the sending of the ICMP packet and the receiving of the response, the distance metric characterizing a number of intermediary network components that exist between the first and second storage container nodes.

12. The system of claim 9, wherein the identifying of the at least one additional storage container node is further based on at least one distance parameter characterizing a physical distance constraint applied to data storage in the storage container node cluster.

13. The system of claim 12, wherein the identifying of the at least one additional storage container node is further based on a replication factor characterizing a number of additional storage container nodes data is to be replicated to.

14. The system of claim 9, wherein the processor is further configured to:
send a packet to each of the plurality of storage container nodes; and
receive a response from each of the plurality of storage container nodes.

15. The system of claim 14, wherein the plurality of distances characterized by the distance map identifies a distance metric associated with each of the plurality of storage container nodes.

16. The system of claim 15, wherein the processor is further configured to:
identify a plurality of additional storage container nodes for implementation of data replication and propagation services associated with the first storage container node.

17. One or more non-transitory computer readable media having instructions stored thereon for performing a method, the method comprising:
identifying, at a first storage container node, a storage container node cluster including a plurality of storage container nodes;
sending a packet to at least a second storage container node of the plurality of storage container nodes;
receiving a response from the second storage container node, the response including a reply to the packet;
generating a distance map based, at least in part, on the received response, the distance map characterizing a plurality of distances between the plurality of storage container nodes and the first storage container node; and
identifying at least one additional storage container node based, at least in part, on the generated distance map.

18. The one or more non-transitory computer readable media recited in claim 17, wherein the packet is an internet control message protocol (ICMP), and wherein the generating of the distance map further comprises:
generating at least one distance metric based on the sending of the ICMP packet and the receiving of the response, the distance metric characterizing a number of intermediary network components that exist between the first and second storage container nodes.

19. The one or more non-transitory computer readable media recited in claim 17, wherein the identifying of the at least one additional storage container node is further based on at least one distance parameter characterizing a physical distance constraint applied to data storage in the storage container node cluster, and wherein the identifying of the at least one additional storage container node is further based on a replication factor characterizing a number of additional storage container nodes data is to be replicated to.

20. The one or more non-transitory computer readable media recited in claim 17, wherein the method further comprises:
sending a packet to each of the plurality of storage container nodes; and
receiving a response from each of the plurality of storage container nodes,
wherein the plurality of distances characterized by the distance map identifies a distance metric associated with each of the plurality of storage container nodes.
